(19) United States
(12) Patent Application Publication
(10) Pub. No.: US 2005/0116856 A1
(43) Pub. Date: Jun. 2, 2005

(54) Radio-controlled clock and method for acquiring time information from a time signal with reduced evaluation overhead

(75) Inventors: Horst Haefner, Heilbronn (DE); Roland Polonio, Neckarsulm (DE); Hans-Joachim Sailer, Heilbronn (DE)

Correspondence Address: FASSE PATENT ATTORNEYS, P.A., P.O. BOX 726, HAMPDEN, ME, 04444-0726, US

(73) Assignees: ATMEL Germany GmbH, Heilbronn (DE); C-MAX EUROPE GMBH, Heilbronn (DE)

(21) Appl. No.: 10/999,339

(22) Filed: Nov. 29, 2004

(30) Foreign Application Priority Data
Nov. 28, 2003 (DE) 103 56 320.2

(51) Int. Cl. G01S 1/00

(52) U.S. Cl. 342/357.1

(57) ABSTRACT

A time signal provides time and/or date information in a succession of time code telegrams that each include successive time frames having at least one data bit each. The time signal is received, decoded and evaluated to acquire the time information, for which only some of the data bits of a respective time code telegram are evaluated. Particularly, only those bits representing necessary time and/or date information are evaluated, while other bits containing other unneeded information are ignored or replaced by filler bits. A radio-controlled clock includes a bit decoder and an evaluating unit for decoding and evaluating only the pertinent bits, a counter that keeps track of the bit location in the telegram, and a controller that controls the decoder and/or evaluating unit to decode and evaluate only some particular ones of the received data bits in the telegram.

### PRIORITY CLAIM

This application is based on and claims the priority under 35 U.S.C. §119 of German Patent Application 103 56 320.2, filed on Nov. 28, 2003, the entire disclosure of which is incorporated herein by reference.

### FIELD OF THE INVENTION

The invention relates to a method as well as a remotely-controlled or especially radio-controlled clock for acquiring time and/or date information from a time signal transmitted by a time signal transmitter.

### BACKGROUND INFORMATION

It is conventionally known to provide time reference information in time signals that are transmitted by radio transmission from a time signal transmitter. Such a signal may also be called a time marker signal, a time data signal, a time code signal, or a time reference signal, for example, but will simply be called a time signal herein for simplicity. The time signal transmitter obtains the time reference information, for example, from a high precision atomic clock, and broadcasts this highly precise time reference information via the time signal. Thus, any radio-controlled clock receiving the signal can be synchronized or corrected to display the precise time in conformance with the time standard established by the atomic clock that provides the time reference information for the time signal transmitter. The time signal is especially a transmitter signal of short duration, that serves to transmit or broadcast the time reference information provided by the atomic clock or other suitable time reference emitter. In this regard, the time signal is a modulated oscillation generally including plural successive time markers, which each simply represent a pulse when demodulated, whereby these successive time markers represent or reproduce the transmitted time reference with a given uncertainty.

A time signal transmitter as mentioned above is, for example, represented by the German longwave transmitting station DCF-77, which continuously transmits amplitude-modulated longwave time signals controlled by atomic clocks to provide the official atomic time scale for Central European Time (CET), with a transmitting power of 50 kW at a frequency of 77.5 kHz. In other countries, such as Great Britain, Japan, China, and the United States, for example, similar transmitters transmit time information on carrier waves in a longwave frequency range from 40 kHz to 120 kHz. In all of the above mentioned countries, the time information is transmitted in the time signal by means of a succession of time frames organized in time code telegrams that each have a duration of exactly one minute.

FIG. 1 diagrammatically represents the coding scheme of a time code or time information telegram A that pertains for the encoded time information provided by the German time signal transmitter DCF-77. The coding scheme or telegram in this case consists of 59 bits in 59 time frames, whereby each single bit or time frame corresponds to one second. Thus, the so-called time code telegram A, which especially provides information regarding the correct time and date in binary encoded form, can be transmitted in the course of one minute. The first 15 bits in bit range B comprise a general encoding, which contain operating information, for example. The next 5 bits in bit range C contain general information. Particularly, the general information bits C include an antenna bit R, an announcement bit Al announcing or indicating the transition from Central European Time (CET) to Central European Summer Time (CEST) and back again, zone time bits Z1 and Z2, an announcement bit A2 announcing or indicating a so-called leap second, and a start bit S of the encoded time information.

From the 21^{st} bit to the 59^{th} bit, the time and date informations are transmitted in a Binary Coded Decimal (BCD) code, whereby the respective data are pertinent for the next subsequent or following minute. In this regard, the bits in the range D contain information regarding the minute, the bits in the range E contain information regarding the hour, the bits in the range F contain information regarding the calendar day or date, the bits in the range G contain information regarding the day of the week, the bits in the range H contain information regarding the calendar month, and the bits in the range I contain information regarding the calendar year. These informations are present bit-by-bit in encoded form. Furthermore, so-called test or check bits P1, P2, P3 are additionally provided respectively at the ends of the bit ranges D, E and I. The 60^{th} bit or time frame of the time code telegram A is not occupied, i.e. is “blank” and serves to indicate the beginning of the next time frame. Namely, the minute marker M following the blank interval represents the beginning of the next time information or code telegram A.

The structure and the bit occupancy of the encoding scheme or telegram A shown in FIG. 1 for the transmission of time signals is generally known, and is described, for example, in an article by Peter Hetzel entitled “Zeitinformation und Normalfrequenz” (“Time Information and Normal Frequency”), published in Telekom Praxis, Vol. 1, 1993.

The transmission of the time marker or code information is performed by amplitude modulating a carrier frequency with the individual second markers. More particularly, the modulation comprises a dip or lowering or reduction X1, X2 (or alternatively an increase or raising) of the carrier signal X at the beginning of each second, except for the 59^{th} second of each minute, when the signal is omitted or blank as mentioned above. In this regard, in the case of the time signal transmitted by the German transmitter DCF-77, the carrier amplitude of the signal is reduced, to about 25% of the normal amplitude, at the beginning of each second for a duration X1 of 0.1 seconds or for a duration X2 of 0.2 seconds, for example as shown in present FIG. 2.

These amplitude reductions or dips X1, X2 of differing duration respectively define second markers or data bits in decoded form. The differing time durations of the second markers serve for the binary encoding of the time of day and the date, whereby the second markers X1 with a duration of 0.1 seconds correspond to the binary “0” and the second markers X2 with the duration of 0.2 seconds correspond to the binary “1”. Thus the modulation represents a binary pulse duration modulation. As mentioned above, the absence of the 60^{th} second marker announces the next following minute marker.

Thus, in combination with the respective second, it is then possible to evaluate the time information transmitted by the time signal transmitter. FIG. 2 shows a portion of an example of such an amplitude modulated time signal as discussed above. Note that the total duration of each pulse and gap or second marker X1 or X2 amounts to 1000 ms or 1 second, while the individual gaps or amplitude reductions acting as second markers X1 and X2 respectively have individual durations of 100 ms or 200 ms, i.e. 0.1 seconds or 0.2 seconds, as described above. The general technical background of radio-controlled clocks and receiver circuits for receiving time signals as generally discussed above are disclosed in the German Patent Publications DE 198 08 431 A1, DE 43 19 946 A1, DE 43 04 321 C2, DE 42 37 112 A1, and DE 42 33 126 A1. Furthermore, the methods and techniques for acquiring and processing the time information from transmitted time signals are disclosed in Patent Publications DE 195 14 031 C2, DE 37 33 965 C2, EP 0,042,913 B1, and DE 195 14 036 C2.

In present-day conventional radio-controlled clocks, all 59 second markers of each respective minute are always decoded and evaluated for acquiring and processing the time information. Moreover, the evaluation and determination of the exact correct time and the exact correct date are thus only possible if all 59 second markers of a respective minute have been unambiguously received and recognized, and thus a corresponding binary value can be unambiguously allocated to each one of these second markers in the evaluation. It is thus problematic in such conventional methods and techniques, that the received time signal is often considerably obscured or falsified by superimposed interference signals arising from various interference sources or fields. Depending on the type and scope of the interference signals, the interference can thus lead to an erroneous reception and evaluation of the time signal. In this context, the term “erroneous” means that errors are made in the determination and allocation of binary values to the bits in the evaluation of the received time code telegram or minute protocol. Namely, due to the interference and the consequent erroneous binary determination, at least one of the data bits of the minute protocol is erroneously evaluated.

Generally, when existing conventional radio-controlled clocks and receiver circuits suffer from such interference during the reception of a time signal, which no longer permits the error-free and unambiguous evaluation of the second markers of the time code telegram, the evaluation and the reception of the time signal for the present progressing minute are usually terminated. Then, the reception and evaluation begins anew for the next time code telegram or minute protocol of the time signal. In this case, the reception and evaluation must be continued so long until a correct reception and evaluation of the time signal was possible for an entire minute, i.e. during an entire time code telegram or minute protocol, so that all 59 second bits have been correctly received and evaluated and are thus available for determining the correct time and the correct date. Thereafter, the reception continues for another minute to again evaluate a complete time code telegram, so as to then carry out a comparison of the two evaluated time code telegrams for the purpose of a plausibility check thereof.

In environments having a great deal of interference, for example in large cities, in the proximity of industrial plants or complexes, in office buildings in which a large number of data monitors and computer devices are present, or the like, there is typically a large degree of interference arising due to the operation of many electrical and electronic devices. This creates a background “inference fog” which strongly interferes with the proper reception and evaluation of the time signal. Namely, with such an “interference fog” it is often only possible to correctly receive and evaluate a time code telegram after a rather long time, i.e. after the passage of several time code telegrams that suffered erroneous reception or evaluation. As a result, the time signal receiver of the radio-controlled clock must remain active for a correspondingly long time. This becomes problematic in time signal receivers having a limited energy supply, for example powered by a battery or an accumulator, because the limited available electrical energy will be used-up rather quickly since the signal receiving and evaluating circuitry must remain active for long periods of time, i.e. a high duty ratio of active operating time relative to inactive or standby time.

If the above types of interference are severe, it may occur that an interference-free proper reception and evaluation of the time signal only becomes possible during the night hours, when at least some of the interference sources (e.g. business office computers, industrial plant equipment, or the like) are switched off. As a result, the erroneous and thus unsuccessful reception of the time signal can continue during an entire day, until a proper reception of the time signal is achieved during the night. During the daytime hours with no acquisition of the time reference signal, the displayed clock time may deviate from the true reference time provided by the time signal. Moreover, when newly starting the time signal receiver, i.e. the radio-controlled clock, for example after exchanging the batteries thereof or the like, the clock will display the wrong time until the time signal is correctly received and evaluated, which might only be achieved during the subsequent night, as explained above.

For the above reasons, it is needed in this field, to reduce the evaluation overhead, and avoid the problems of reception interference as described above, in order to reduce the power consumption by the time signal receiver, and in order to enable proper reception and evaluation of the time signal so as to achieve synchronization of the clock with the time reference information more quickly despite the existence of interference.

### SUMMARY OF THE INVENTION

In view of the above, it is an object of the invention to reduce the interference sensitivity in the acquisition and evaluation of time information from a transmitted time signal. The invention further aims to avoid or overcome the disadvantages of the prior art, and to achieve additional advantages, as apparent from the present specification. The attainment of these objects is, however, not a required limitation of the claimed invention.

The above objects have been achieved according to the invention in a method for acquiring time and/or date information from a received time signal, wherein the time signal comprises a plurality of time frames of constant duration, wherein each time frame includes at least one data bit, and the data bits represent the time and/or date information. Especially according to the invention, only a predetermined portion (less than all) of the data bits of a minute protocol of the time code telegram of the received time signal are evaluated for acquiring the time and/or date information. A final determination of the time and/or date information is made based on the evaluation of the predetermined portion of the data bits, rather than requiring an evaluation of all of the data bits of the entire minute protocol.

The above objects have further been achieved according to the invention in a remote-controlled and especially a radio-controlled clock for receiving and acquiring time and/or date information from a received time signal, comprising a receiver circuit adapted and arranged to receive a time signal transmitted by a time signal transmitter, a decoding arrangement or unit adapted to decode at least a predetermined portion of the data bits of the time code telegram of the received time signal, and an evaluating arrangement or unit adapted to evaluate only a predetermined portion of the decoded data bits and determine a time and/or date information therefrom, especially by carrying out a method according to the invention.

The present invention is based on the underlying recognition, that the encoding scheme or time code telegram of a time signal transmitted by a time signal transmitter typically contains more data bits than are needed for evaluating the time and the date. Namely, the telegram includes additional data bits that provide other information not necessary for determining the time and/or the date. The basic idea of the present invention is thus not to decode and evaluate all 59 data bits or second markers of the time code telegram of a time signal for acquiring the time and/or date information. To the contrary, it is completely sufficient according to the invention if only some (i.e. a portion rather than all) of the data bits are decoded and evaluated. Advantageously, the decoded and evaluated portion of the data bits are only those data bits that are directly relevant and necessary for the time and/or date determination. On the other hand, the data bits that are not directly relevant and necessary for the time and/or date determination are initially not taken into consideration, so that any arising interference affecting these irrelevant and non-evaluated data bits will accordingly have no influence on the acquisition of the time and/or date information.

For example, in the typical time code telegram of the German time signal emitted by the German transmitter DCF-77 as described above, only the data bits in the range from the 21^{st} bit to the 59^{th} bit in the course of one minute of the code telegram are decoded and evaluated, since the relevant time and date informations are contained within this specified bit range of the time code telegram. Thereby, the number of data bits that must be decoded and evaluated is reduced from 59 data bits in the conventional method, to a maximum of 39 data bits according to the invention, for each minute of the transmitted time signal.

The other remaining (non-evaluated) data bits, i.e. the data bits in the range from the 1^{st} to the 20^{th} bit, contain essentially only general informations that are not necessarily required for the determination of the radio-controlled time of day and the radio-controlled date.

According to the invention, the interference immunity during the reception of a time signal is significantly increased by simply ignoring or not considering the data bits that are not necessary for the determination of the time and date information. Namely, in the conventional evaluation of all data bits of a time code telegram, it is to be expected that various interferences may affect individual data bits of the telegram. By ignoring or not considering individual bits in the telegram, which are not directly needed for determining the time and the date, the inventive method thus reduces the probability that the interference will have an influence on the decoding of the time signal. In other words, since only a portion or fraction of all of the data bits of the telegram is taken into consideration and evaluated in the inventive method, thereby the interference insensitivity or immunity of the method is also correspondingly increased.

An interference that affects an unimportant data bit that is not taken into consideration and not evaluated can thus have no direct effect on the reception of the time signal according to the invention. In other words, this means that the data bits that are not considered and not evaluated in the inventive method may be superimposed with an interference signal that would make an evaluation of these data bits entirely impossible, yet the interference has no influence on the proper execution of the inventive method. Namely, it is entirely irrelevant to the inventive method whether or not the unimportant and unevaluated bits are properly received without interference or entirely obscured by interference. Any existing interference of the unimportant and unevaluated data bits is no longer relevant to the inventive method and system, so that the overall method and system still provides an acceptable and reliable result of the determined time and date information, even when the received signal suffers more or less strongly from interference influences.

Through this manner of evaluation of the time signal, especially also the reception, security and reliability of radio-controlled clock systems can be significantly increased. The signal content of a received time signal can thus still be used according to the invention, even if the signal suffers interference that makes it impossible for software evaluation processes according to the conventional state of the art to decode the data bits for acquiring the time and date information. As a result, an increased reception distance or range of the reception of the time signals is possible for the user of the method and system according to the invention.

A further advantage of the present invention is seen in a reduction of the time between the initial start-up or resetting of a radio controlled clock (e.g. after replacing the batteries) and the time at which the correct radio-controlled time and date information is first available, especially in connection with the reception of time signals that have interference signals superimposed thereon. Especially in large cities, in which the available time signals are corrupted by the superposition of interference signals caused by electrical and electronic devices, the provision of a system that is immune or insensitive to interference in the reception of time signals is becoming evermore important.

According to the invention, since only some or a portion of the data bits of a time code telegram of a received time signal are decoded and/or evaluated, this also achieves a reduction of the computational effort, circuitry and general evaluation overhead in a computer or processor unit for carrying out the decoding and evaluating. This processor unit, which is typically embodied as a 4-bit micro-controller, can thus operate with a reduced overall power consumption, and/or remains increasingly available for other computational tasks, such as control tasks, monitoring tasks, the processing or provision of other informations, and the like. As mentioned, it is also significant that a reduction of the computational overhead also achieves a reduction of the power consumption and thus energy consumption, so that the local energy supply, which is often a limited energy supply (e.g. battery or accumulator), in a radio-controlled clock can have a longer operating life. This is an especially significant advantage relative to conventional systems, particularly in radio-controlled clocks and radio-controlled clock receivers that are embodied or incorporated in wrist watches.

The inventive method is especially suitable in those situations in which the data bits that do not contain any time and date informations have already been decoded and evaluated once previously, i.e. in a prior time code telegram during a prior minute. Typically, such data bits, which typically contain general coding information and test or check bits, change or vary less often than the data bits containing time and date informations. As a result, once these data bits relating to general coding information or the like have been evaluated in one time code telegram, they do not need to be continuously or repeatedly again decoded and evaluated in the following successive time code telegrams.

In a very advantageous embodiment of the invention, only those data bits that are directly relevant for determining the time are decoded and evaluated. Thus, in comparison to the above described embodiment of the inventive method, in this further embodiment even the data bits that contain the date information are not decoded and not evaluated. This alternative embodiment of the inventive method is beneficial because the date information, of course, does not change as often as the time information, and the local date information of the radio-controlled clock does not need to be updated and re-synchronized as often (essentially only when initially starting or restarting the clock). This alternative embodiment of the inventive method is especially also advantageous in radio-controlled clocks that do not even indicate or display the date information. For example, this applies to radio-controlled clocks having only an analog time display.

A particular example of this embodiment of the invention is given for the German time code telegram in the time signal transmitted by the German time signal transmitter DCF-77. Particularly, in this German time code telegram, it is sufficient if only the data bits in the range from the 21^{st} bit to the 35^{th} bit, i.e. the data bits giving the hour and minute information, within a given minute protocol are decoded and evaluated. Thereby, the number of data bits to be decoded and evaluated is reduced from 59 data bits in the prior art to 15 data bits according to the invention.

The 28^{th}, 35^{th} and 58^{th} data bits respectively contain neither time information nor date information, but rather only test or check information. In a further embodiment of the invention, at least one (or all) of these data bits are also not decoded and not evaluated. Similarly, the 59^{th} bit, which is vacant or unoccupied, as well as the 21^{st} data bit, do not necessarily have to be taken into consideration.

In yet another embodiment of the present invention, the portion of the data bits that are not evaluated for acquiring the time and/or date informations are nonetheless decoded. After the decoding, but before the bit sequence is passed to the evaluation, these decoded data bits that are not necessary for acquiring the time and/or date information are replaced or represented by a prescribed filler bit or dummy bit. Such a filler bit or dummy bit is a bit having a predefined logic value, for example a logic 0 or a logic 1. The evaluating arrangement according to the invention is specifically designed and adapted to recognize and then ignore or not evaluate these filler bits or dummy bits.

In a further alternative to the preceding embodiment, the portion of the data bits that are not to be evaluated for acquiring the time and/or date informations are also not decoded, i.e. these bits are neither decoded nor evaluated.

The respective exact position of a given data bit in the time code telegram of the time signal is determined on the basis of a counter. In this regard, the count value of the counter is incremented or increased by one per each data bit beginning with a first data bit. Upon reaching the last data bit of a minute in the time code telegram of the time signal, the counter is again reset and begins anew to count up the data bits starting at the first data bit of the next successive minute. Alternatively, the counter may be decremented rather than incremented by one for each successive data bit.

Furthermore, a binary value is assigned or allocated to each respective data bit, whereby the binary value is derived from the duration of a characteristic parameter, e.g. the amplitude of the signal. Namely, a first duration of the change of the amplitude of the time signal represents a first logic value of the data bit, and a second duration of a change of the amplitude of the time signal represents a second logic value of the data bit. These first and second durations are predetermined by the particular encoding scheme or time code telegram of the time signal transmitter. Typically, the first logic value represents a logic “0” (low logic and voltage level) while the second logic value represents a logic “1” (high logic and voltage level). Of course, an opposite or reversed logic allocation is also useable according to the invention. In most time code telegrams of a time signal transmitted by a time signal transmitter, a relevant change or variation of the amplitude of the signal is specifically embodied as a temporary dip, lowering or reduction of the amplitude of the time signal. Of course, the opposite or reversed signal logic is also possible, namely carrying out the binary encoding through data bits represented by temporary increases or elevated pulses of the amplitude.

The invention further provides a control arrangement that has its input connected to an output of the above mentioned counter, and has its output connected to one or more control inputs of the decoding and evaluating arrangement. The counter value indicates at which position within the time code telegram a respective current decoded data bit or the corresponding time marker signal is actually and presently located. Dependent on the counter value of the counter, the control arrangement generates a selection signal, which is provided to the decoding and evaluating arrangement. The control arrangement thereby activates and controls the decoding and evaluating arrangement on the basis of the selection signal in such a manner so that only the data bits that contain or represent the desired date and/or time informations are selected. The selected data bits are then decoded and evaluated, and the corresponding date and/or time informations are determined from the evaluated bits.

Which data bits in a given time signal contain the date and/or time informations depends on the particular telegram format utilized by the time signal transmitter that is transmitting the given time signal. In this regard, the format of a time code telegram can vary more or less strongly in various different time signal transmitters. For this reason, in a very advantageous embodiment of the invention, the inventive apparatus includes a memory arrangement in which the pertinent parameters of various different formats of the possible time code telegrams of various different time signal transmitters are stored. For example, the memory arrangement can be embodied in the form of a look-up table, or as a hard-wired logic circuit, for example as a programmable logic array (PLA or PLD) circuit or a field-programmable logic array (FPLA) circuit.

### BRIEF DESCRIPTION OF THE DRAWINGS

In order that the invention may be clearly understood, it will now be described in connection with example embodiments thereof, with reference to the accompanying drawings, wherein:

FIG. 1 schematically represents the encoding scheme or time code telegram of encoded time information transmitted by the German time signal transmitter (DCF-77), as conventionally known;

FIG. 2 is a time diagram representing a portion of an amplitude modulated time signal having five second markers as transmitted by the time signal transmitter without interference;

FIG. 3 schematically represents an evaluation, according to the inventive evaluation method, of an encoding scheme of the time signal transmitted by the transmitter DCF-77;

FIG. 4 schematically represents a further example embodiment of the evaluation, according to the inventive evaluation method, of an encoding scheme of the time signal transmitted by the transmitter DCF-77;

FIG. 5 is a schematic time diagram of a portion of a time signal in connection with which the inventive method is explained; and

FIG. 6 is a schematic block circuit diagram of the strongly simplified construction of a radio-controlled clock according to the invention.

### DETAILED DESCRIPTION OF PREFERRED EXAMPLE EMBODIMENTS AND OF THE BEST MODE OF THE INVENTION

In all of the drawing figures, the same elements and signals, as well as the elements and signals respectively having the same functions, are identified by the same reference numbers, unless the contrary is indicated.

The general format of an encoding scheme or time code telegram A as conventionally known in the time signal transmitted by the German time signal transmitter DCF-77 has been explained above in the Background Information section. Similarly, the time-variation of the amplitude-modulated time signal is schematically shown in the time diagram of FIG. 2 and has been discussed above as well.

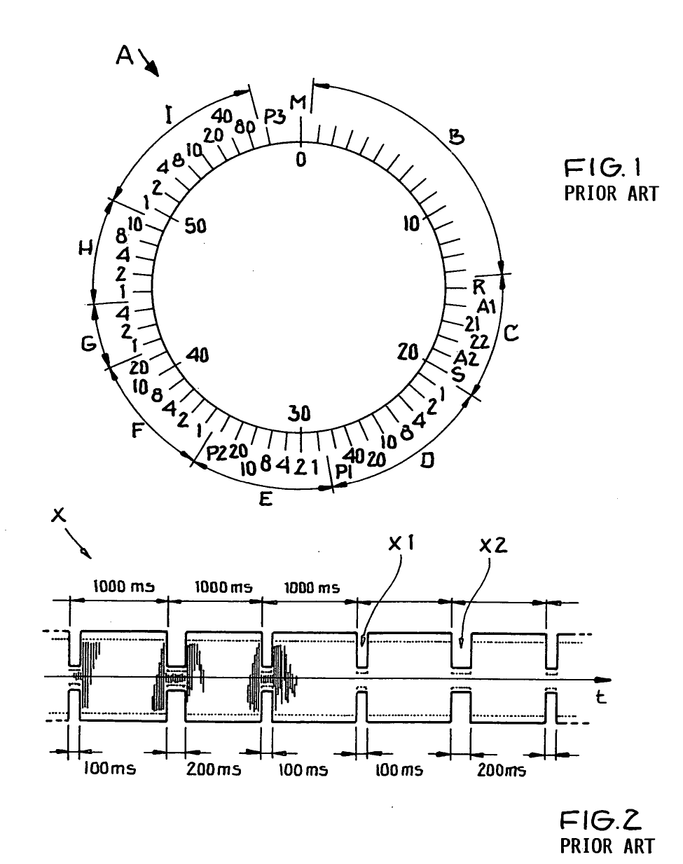

In comparison to FIG. 1, FIG. 3 now represents a first example embodiment of an encoding scheme, and particularly an evaluation of the encoding scheme, of the time signal emitted by the German time signal transmitter DCF-77 according to the inventive method. In comparison to the conventional encoding and evaluation scheme A according to FIG. 1, in the inventive encoding and evaluation scheme A′ according to FIG. 3, only those data bits in the bit ranges D, E, F, G, H and I of the time code telegram A′ are taken into account for acquiring the time and date informations. Namely, this means that only the 21^{st} to 59^{th} data bits, which contain the pertinent date and time informations, are evaluated. The remaining data bits in the other bit ranges B and C (see FIG. 1) are not identified in FIG. 3, to indicate that these data bits are not used (i.e. not evaluated) in the inventive method.

Furthermore, it can be provided according to the invention that the test or check bits P1, P2 and P3 are not taken into consideration because they are not absolutely necessary for acquiring the time and date informations. Thus, these test bits P1, P2 and P3 indicated in the conventional time code telegram A of FIG. 1 are not indicated or referenced in the inventive time code telegram evaluation A′ in FIG. 3. Thus, in the inventive evaluation of the time code telegram A′, there are only 36 to 39 data bits remaining, which are decoded and evaluated for acquiring the date and time informations.

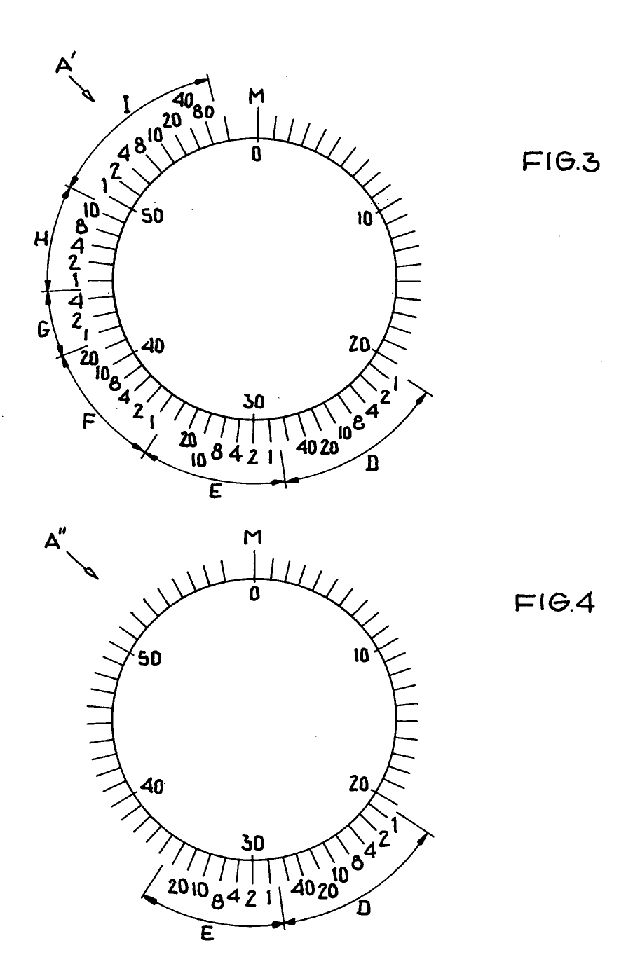

FIG. 4 shows a further second example embodiment according to the invention, of the evaluation of an encoding scheme or time code telegram A″ of the time signal emitted by the German transmitter DCF-77. In this time code telegram A″ according to FIG. 4, only those data bits in the bit ranges D and E, i.e. from the 21^{st} to the 35^{th} data bit are taken into consideration in the inventive evaluation. These bit ranges D and E are particularly only those ranges that contain the time information, i.e. the necessary hour and minute information. In comparison to the first example embodiment of the evaluation of the time code telegram A′ according to FIG. 3, the present embodiment of FIG. 4 does not take into consideration the bit ranges F, G, H and I, which contain the date information. Just as in the example embodiment of FIG. 3, the present embodiment of FIG. 4 similarly can omit or exclude the test bits P1 and P2 from the evaluation, without giving rise to errors in the time information. In this example embodiment according to FIG. 4, only a total of 13 to 15 data bits must be evaluated for acquiring the time information.

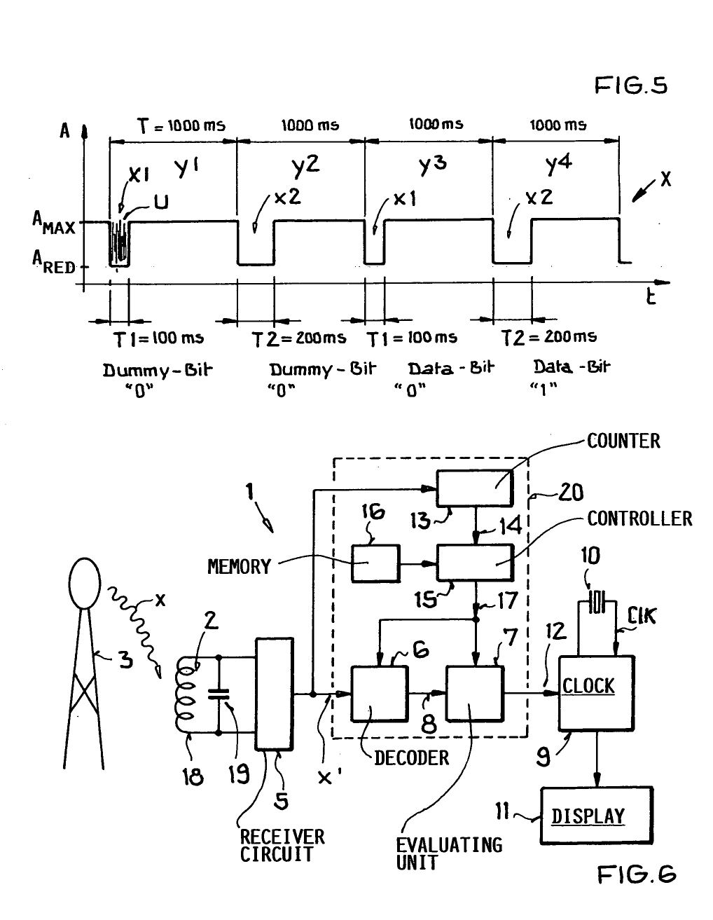

FIG. 5 schematically represents a small portion of a time signal in a time diagram for explaining the inventive method. The example illustrated in FIG. 5 is not suitable for representing or forming a special encoding. The time scale along the horizontal time axis can be understood from the periods or intervals represented as 100 ms, 200 ms, and 1000 ms respectively.

The portion shown in FIG. 5, for example, illustrates four complete time frames Y1, Y2, Y3, and Y4 of the time signal X. The duration of each respective time frame Y1 to Y4 respectively amounts to T=1000 ms or 1 second. Each time frame Y1 to Y4 contains exactly one second marker X1 or X2 that respectively contains or is represented by a data bit. Namely, these second markers X1 and X2 are represented by respective temporary dips, reductions or lowerings of the amplitude A of the time signal X from the normal maximum signal amplitude A_{MAX} to the reduced dip amplitude A_{RED}. The particular time signal X emitted by the German transmitter DCF-77, for providing a binary encoding, includes exactly two different second markers, namely the first amplitude dip or reduction X1 with a duration T1=100 ms, and a second amplitude dip X2 with the duration T2=200 ms. In this regard, the first dip X1 with the duration T1=100 ms can be allocated to a binary zero (“0” or low signal), while the second dip X2 of the duration T2=200 ms can be allocated to a binary one (“1” or high signal). In this regard, a binary 1 and binary 0 respectively correspond to a data bit. Thus, each time frame Y1, Y2, Y3 and Y4 respectively contains or represents one data bit of the overall time signal X.

In the example shown in FIG. 5, the time frames Y1, Y2, Y3 and Y4 respectively correspond to the 19^{th} to 22^{nd} data bits of the time code telegram A′ of FIG. 3. In order to acquire the time and date information, only the 21^{st} and 22^{nd} data bits, and thus correspondingly the time frames Y3 and Y4 are relevant in the portion of the signal shown in FIG. 5. On the other hand, the time frames Y1 and Y2 respectively contain the 19^{th} and 20^{th} data bits, namely the announcing bit A2 and the start bit S, which are not absolutely necessary for determining the time. Accordingly, these two time frames Y1 and Y2 are not taken into consideration in the inventive method for the time determination.

In the example shown in FIG. 5, it is assumed that a temporary or intermittent interference signal U happens to be superimposed on the time signal X during the first time frame Y1. While the interference signal U is not significant in comparison to the full or maximum amplitude A_{MAX} of the time signal X, the strength or amplitude of the interference signal U is sufficient to completely obscure the amplitude reduction of the time signal X during the first amplitude dip X1 down to the reduced signal amplitude A_{RED}. Thus, the superimposed interference signal U makes it impossible to recognize and decode this second marker X1. As a result, the conventional evaluation method would terminate at this point, because an error-free decoding of all second markers and thus all data bits is necessary for completing the conventional method, but is not possible due to the interference U. So, the conventional method would have to repeat the evaluation for the next received time code telegram, in hopes that there will then be no further interference.

On the other hand, the present inventive method is not influenced at all by the interference U during the first second marker X1 of the time frame Y1, because the data bit of the first time frame Y1 is not taken into consideration at all in the inventive method, since it is not relevant for the direct determination of the time and date. Accordingly, without regard to the actual amplitude or signal value received during the pertinent time portion of the first and second time frames Y1 and Y2, the inventive method substitutes or allocates a dummy bit, e.g. a logic “0” in the present example embodiment, for the corresponding second markers of these time frames Y1 and Y2. Thus, the second marker X1 of the first time frame Y1 has the dummy bit “0” allocated to it, even though it would not have been otherwise decodable due to the superimposed interference signal U.

Next in the inventive method, the two second markers X1 and X2 respectively in the time frames Y3 and Y4 are decoded. Namely, it so happens that there is no interference during the time frames Y3 and Y4, so that the amplitude dips X1 and X2 can be recognized during these time frames Y3 and Y4, and the respective duration thereof evaluated, so as to allocate a logic zero to the data bit in the time frame Y3 and allocate a logic one to the data bit in the time frame Y4. Then, for determining the time and date, these two data bits of the time frames Y3 and Y4 are evaluated (along with the further data bits that are relevant for the time and date determination). Advantageously, the two dummy bits that were inserted in place of the bit values in the time frames Y1 and Y2 are ignored in the further evaluation process, based on a bit evaluation control or selection signal provided by a controller as will be discussed below.

FIG. 6 is a strongly simplified block circuit diagram of a radio-controlled clock according to the invention. The radio-controlled clock 1 comprises one or more antennas 2 for receiving time signals X transmitted by the time signal transmitter 3. In the present example embodiment, the single antenna 2 is constructed as a coil 18 with a ferrite core, with a capacitive element 19, e.g. a capacitor, connected in parallel thereto. A receiver circuit 5 adapted to receive the time signal X emitted by the transmitter 3 is connected after or downstream of the antenna 2. The receiver circuit 5 typically comprises one or more filters, for example a bandpass filter, a rectifier circuit, and an amplifier circuit respectively adapted to filter, rectify and amplify the received time signal X. The construction and operation of such a receiver circuit 5 can be according to any conventionally known teachings, for example according to the above mentioned prior art documents, so that a detailed description thereof is not necessary here.

The inventive radio-controlled clock 1 further comprises a decoding arrangement or unit 6 that is connected after or downstream of the receiver circuit 5 and serves to decode the filtered, rectified and amplified time signal X′, which may be carried out according to conventionally known processes or techniques. An evaluating arrangement or unit 7 is connected after or downstream of the decoding arrangement 6 and serves to evaluate the decoded signal 8 that is output by the decoding arrangement 6. In this regard, the evaluating arrangement 7 is designed, constructed and adapted to process and evaluate the sequence of data bits received from the decoding unit 6 in the decoded signal 8, and to calculate or otherwise determine therefrom an exact time of day and an exact date, which may be carried out according to conventionally known processes or techniques. The evaluating arrangement 7 produces a corresponding output signal 12 dependent and based on and indicative of that determined time and date.

The radio-controlled clock 1 further comprises an electronic clock 9, of which the local clock time is controlled or regulated by a reference clock signal CLK generated by a clock quartz crystal or oscillator 10. The electronic clock 9 is further connected to a display 11 or some other indicator, by which the clock time is indicated. In addition to the local clock signal CLK, the electronic clock 9 also receives the output signal 12 of the time and date from the evaluating unit 7. The electronic clock 9 can then correct, update, or synchronize its displayed time and date information on the basis of the time and date information provided by the signal 12, which is based on the atomic clock time and date reference information provided through the time signal X.

Still further, the radio controlled clock 1 comprises a counter 13 having an input that receives the filtered, rectified and amplified and sampled time signal X′ provided at the output of the receiver circuit 5. Thus, the counter value of the counter 13 will be respectively incremented or decremented by one for each data bit beginning with a first data bit of one minute in the time code telegram of the time signal. Then, a counter value signal 14 provided at the output of the counter 13 indicates the existing counter value of the counter 13, which correspondingly indicates the relative time frame or bit position within the time code telegram that is being decoded and evaluated at present in the decoding and evaluating arrangements 6 and 7. This counter value signal 14 is provided to a control unit or arrangement 15, which, dependent on the counter value signal 14, generates a control signal 17 that is provided back to the decoding arrangement 6 and/or the evaluating arrangement 7.

Based on the control signal 17, the decoding arrangement 6 and/or the evaluating arrangement 7 will then ignore, i.e. not consider, not decode and/or not evaluate, one or more predetermined data bits or time frames within the respective time code telegram.

In other words, as generally described above, the control unit 15 instructs the decoding arrangement 6 and the evaluating arrangement 7 via the control signal 17, which data bits are not to be considered and which data bits are to be considered. For example, as discussed above, according to the invention only the data bits in the bit ranges D to I (FIG. 3) or in the bit ranges D and E (FIG. 4) will be decoded and/or evaluated. Thus, the control arrangement 15 carries out a selection of which data bits are to be taken into consideration and which data bits are not, and controls the units 6 and 7 so as not to decode and/or evaluate the bits in the ranges B and C (FIG. 3) or ranges B, C and F to I (FIG. 4).

The radio-controlled clock 1 still further comprises a memory arrangement 16, in which various different bit selection protocols, i.e. respectively associated with various different time code telegram formats used in various different countries, are stored. For example, this memory arrangement or unit 16 can be embodied as a look-up table. In this manner, the inventive method may advantageously remain functional with various different time code telegram formats of the received time signal X, so that this radio-controlled clock 1 can be used in various different countries. Thus, more particularly, the memory arrangement 16 stores not only parameters or characteristic information about the respective time code telegram formats, but also respective informations indicating which specific bits in the various different telegram formats shall be ignored, i.e. not decoded and/or not evaluated, because they are not mandatory of the determination of the time and/or date as desired. The memory arrangement 16 may also store information regarding how an ignored data bit is to be further handled or processed, for example, whether it shall be replaced or occupied by a filler bit or a dummy bit, or whether it shall be neither decoded nor evaluated in the first place.

In the inventive radio-controlled clock 1, several components, for example the decoding arrangement 6, the evaluating arrangement 7, the counter 13, the control arrangement 15, and the memory arrangement 16 can be embodied in a program-controlled arrangement or particularly a micro-controller 20. Alternatively, the functions of these various units could be carried out in part or entirely in appropriate software as corresponding program functions or modules. As a further alternative, some or all of the various units and their functions could be embodied in corresponding hard-wired circuit components.

The illustrated and explained example embodiment is merely one possible example of a concrete circuit for embodying an inventive receiver circuit and radio-controlled clock. This example embodiment can readily be varied by exchanging individual or simple circuit components or entire functional blocks or units, as would be understood by a person of ordinary skill in the art.

In the above described example embodiments, the time encoding was realized by a temporary dip or reduction of the signal amplitude of the carrier signal at the beginning of each respective time frame. It should be understood that the encoding could alternatively be realized by a temporary increase or any other variation of the signal amplitude of the carrier signal in each respective time frame. Other types of signal modulation could alternatively be used.

While the above described particular example embodiments of the invention evaluated particular identified ranges of the data bits in the encoding scheme of a time signal, the inventive method is not limited to these particular bit ranges. Instead, the inventive method could decode and evaluate bits of other bit ranges, for example only the data bits comprising or containing date information but not time information (e.g. if the particular application at issue is for a radio-controlled calendar without time information).

The invention is also not limited to the particular numerical ranges or indications disclosed herein as examples. To the contrary, the scope of the invention also covers variations or changes of numerical values and ranges, e.g. other data bit ranges in telegrams according to other protocols, as would be understood by a person of ordinary skill in the art.

While the above discussion has especially related to a radio-controlled clock receiving the time signal via a wireless radio transmission, the present invention also relates to a method and clock apparatus receiving a time signal via a hard-wired transmission. For example, systems including several clocks that are to be synchronized with one another and that are connected to each other by a time signal wire for this purpose, can also be embodied according to the present invention, and are covered within the scope of the appended claims. Such clocks may be generally regarded as remote-controlled clocks, but are also to be understood within the term radio-controlled clocks.

Although the invention has been described with reference to specific example embodiments, it will be appreciated that it is intended to cover all modifications and equivalents within the scope of the appended claims. It should also be understood that the present disclosure includes all possible combinations of any individual features recited in any of the appended claims.

1. A method of acquiring time and/or date information from a time and/or date signal, comprising the steps:
a) receiving a time and/or date signal comprising a succession of time code telegrams that each comprise a succession of time frames respectively having a fixed duration, wherein said time frames each respectively comprise at least one data bit, said data bits of each respective one of said telegrams include at least one of a first set of said data bits that encode a time information and a second set of said data bits that encode a date information, as well as at least a third set of said data bits that encode other information not necessary for said time information and/or said date information; and
b) acquiring at least one of said time information and said date information by evaluating only a predetermined portion of said data bits and not evaluating others of said data bits of a respective one of said telegrams.

2. The method according to claim 1, wherein said step b) includes acquiring both said time information and said date information, and wherein said predetermined portion of said data bits that are evaluated in said step b) includes only those of said data bits that are directly relevant for determining said time information and said date information.

3. The method according to claim 2, wherein said predetermined portion of said data bits includes only said first and second sets of said data bits, and said others of said data bits include at least said third set of said data bits.

4. The method according to claim 1, wherein said step b) includes acquiring both said time information and said date information, each one of said telegrams respectively includes fifty-nine of said time frames and a blank interval in succession, each one of said time frames respectively comprises a single one of said data bits, each one of said time frames and said blank interval respectively has said fixed duration of one second, each one of said telegrams has a duration of one minute, and said others of said data bits that are not evaluated in said step b) comprise the respective data bits of first to twentieth time frames in said succession of said time frames in a respective one of said telegrams.

5. The method according to claim 4, wherein said predetermined portion of said data bits that are evaluated in said step b) are the respective data bits of twenty-first to fifty-ninth time frames in said succession of said time frames in said respective one of said telegrams.

6. The method according to claim 4, wherein said others of said data bits that are not evaluated in said step b) further comprise the respective data bit of at least one of twenty-first, twenty-eighth, thirty-fifth, fifty-eighth, and fifty-ninth time frames in said succession of said time frames in a respective one of said telegrams.

7. The method according to claim 1, wherein said step b) includes acquiring only said time information and not acquiring said date information, and wherein said predetermined portion of said data bits that are evaluated in said step b) includes only those of said data bits that are directly relevant for determining said time information.

8. The method according to claim 7, wherein said predetermined portion of said data bits includes only said first set of said data bits, and said others of said data bits include at least said second and third sets of said data bits.

9. The method according to claim 1, wherein said step b) includes acquiring only said time information and not acquiring said date information, each one of said telegrams respectively includes fifty-nine of said time frames and a blank interval in succession, each one of said time frames respectively comprises a single one of said data bits, each one of said time frames and said blank interval respectively has said fixed duration of one second, each one of said telegrams has a duration of one minute, and said others of said data bits that are not evaluated in said step b) comprise the respective data bits of first to twentieth and thirty-sixth to fifty-ninth time frames in said succession of said time frames in a respective one of said telegrams.

10. The method according to claim 9, wherein said predetermined portion of said data bits that are evaluated in said step b) are the respective data bits of twenty-first to thirty-fifth time frames in said succession of said time frames in said respective one of said telegrams.

11. The method according to claim 9, wherein said others of said data bits that are not evaluated in said step b) further comprise the respective data bit of at least one of twenty-first, twenty-eighth, and thirty-fifth time frames in said succession of said time frames in a respective one of said telegrams.

12. The method according to claim 1, wherein said step b) includes acquiring only said date information and not acquiring said time information, said predetermined portion of said data bits that are evaluated in said step b) includes only said second set of said data bits, and said others of said data bits that are not evaluated in said step b) include at least said first and third sets of said data bits.

13. The method according to claim 1, wherein each one of said telegrams respectively includes fifty-nine of said time frames and a blank interval in succession, each one of said time frames respectively comprises a single one of said data bits, each one of said time frames and said blank interval respectively has said fixed duration of one second, each one of said telegrams has a duration of one minute, and said predetermined portion of said data bits that are evaluated in said step b) includes no more than thirty-nine of said data bits in a respective one of said telegrams.

14. The method according to claim 13, wherein said predetermined portion of said data bits that are evaluated in said step b) includes no more than fifteen of said data bits in a respective one of said telegrams.

15. The method according to claim 13, wherein said predetermined portion of said data bits that are evaluated in said step b) includes no more than thirteen of said data bits in a respective one of said telegrams.

16. The method according to claim 1, further comprising, before said step b), an additional step of decoding all of said data bits including said predetermined portion and said others of said data bits of said respective one of said telegrams, and, after said decoding, replacing said others of said data bits with respective predefined filler bits or dummy bits.

17. The method according to claim 16, wherein said evaluating omits said filler bits or dummy bits so as to thereby not evaluate said others of said data bits.

18. The method according to claim 1, further comprising, before said step b), an additional step of decoding only said predetermined portion of said data bits without decoding said others of said data bits of said respective one of said telegrams.

19. The method according to claim 1, further comprising incrementing or decrementing a counter respectively by one for each one of said data bits in succession beginning with a first one of said data bits of said respective one of said telegrams, and controlling said evaluating and said not evaluating of respective ones of said data bits in said step b) in response to and dependent on a counter value of said counter.

20. The method according to claim 1, wherein each one of said data bits respectively has a respective bit duration of a temporary variation of an amplitude of said time and/or date signal, a first duration value of said bit duration is allocated to a first logic value, and a second duration value of said bit duration is allocated to a second logic value.

21. The method according to claim 20, wherein said first logic value is a binary logic zero, and said second logic value is a binary logic one.

22. The method according to claim 20, wherein said temporary variation is a temporary dip of said amplitude.

23. The method according to claim 1, wherein said receiving in said step a) further comprises receiving an interference signal superimposed on at least some of said others of said data bits in a manner that obscures bit values of said some of said others of said data bits, and despite said interference continuing with said evaluating of said predetermined portion of said data bits.

24. The method according to claim 1, wherein said receiving comprises wirelessly receiving said signal as a radio signal via a radio antenna.

25. A remotely controlled clock adapted to acquire time and/or date information from a received time and/or date signal including a succession of time code telegrams that each include a succession of time frames that each include a respective data bit, and to adjust a local time and/or date displayed by said clock in response to and dependent on said time and/or date information, said remotely controlled clock comprising:
a receiver circuit adapted to receive said time and/or date signal;
a decoding unit that is connected to an output of said receiver circuit and that is adapted to decode at least a portion of said data bits of a respective one of said telegrams so as to provide a decoded signal at an output of said decoding unit;
an evaluating unit that is connected to said output of said decoding unit and that is adapted to evaluate only a predetermined portion of said data bits without evaluating others of said data bits of said respective one of said telegrams provided in said decoded signal so as to acquire said time and/or date information and produce a corresponding information signal indicative of said time and/or date information at an output of said evaluating unit; and
a local clock that is connected to said output of said evaluating unit and that is adapted to adjust a local time and/or date of said local clock in response to and dependent on said information signal.

26. The remotely controlled clock according to claim 25, being a radio-controlled clock further comprising a radio antenna that is connected to an input of said receiver circuit and that is adapted to receive said time and/or date signal wirelessly as a radio signal.

27. The remotely controlled clock according to claim 25, further comprising a counter that has an input connected to said output of said receiver circuit and an output connected at least indirectly to a respective control input of said decoding unit and/or said evaluating unit, and that is incremented or decremented for each one of said data bits in said respective one of said telegrams so as to produce a counter value indicating a respective bit position in said respective telegram of each successive one of said data bits.

28. The remotely controlled clock according to claim 27, further comprising a controller that is interposed and connected between said output of said counter and said respective control input of said decoding unit and/or said evaluating unit, and that is adapted to produce a bit selection signal in response to and dependent on said counter value of said counter and to provide said bit selection signal to said respective control input of said decoding unit and/or said evaluating unit so as to control said decoding unit and/or said evaluating unit so that only said predetermined portion of said data bits is decoded and/or evaluated.

29. The remotely controlled clock according to claim 25, further comprising a memory in which are stored characteristic parameters or data characterizing at least one particular protocol format of said time code telegrams.
